(19) United States
(12) Patent Application Publication
(10) Pub. No.: US 2024/0278151 A1
(43) Pub. Date: Aug. 22, 2024

(54) LIQUID FILTER AND METHOD FOR INSTALLING ITS FILTERATION PART

(71) Applicant: NANODOCKS TECHNOLOGY LIMITED, Hong Kong (CN)

(72) Inventors: Siu Wah WONG, Hong Kong (CN); Sau Yee CHAU, Hong Kong (CN); Ka Shun NG, Hong Kong (CN)

(21) Appl. No.: 18/522,916

(22) Filed: Nov. 29, 2023

(30) Foreign Application Priority Data
Feb. 17, 2023 (CN) 202320250861.X
Mar. 6, 2023 (WO) PCT/IB2023/052057

(51) Int. Cl. B01D 29/23; B01D 29/58; B01D 39/16

(52) U.S. Cl. CPC B01D 29/23; B01D 29/58; B01D 39/1623; B01D 2201/0415; B01D 2201/325; B01D 2239/025; B01D 2239/1216

(57) ABSTRACT

The present invention is related to a liquid filter having a filtration part for filtration of liquid, said filtration part at least comprising a first filtration layer consisting of a first material; and a second filtration layer consisting of a second material, characterized in that the filtration of liquid in the filtration part is in the order of: a first filtration, taking place at said second filtration layer; and a second filtration, taking place at said first filtration layer. The present invention is further related to a method for installing the liquid filter.

### FIELD OF THE INVENTION

The present invention relates to a liquid filter and a method for installing its filtration part. In particular, the present invention relates to a filtration material at least comprising nanofiber and activated carbon as a filtration part of a water filter, and a method for installing its filtration part.

### BACKGROUND OF THE INVENTION

For water filters available in the market, of which the filtration parts for filtration generally comprise a layer of filtration material with different sizes of filtration pores to filter impurities of different particle sizes. However, the filtration performance of these filtration parts is not only average, but also greatly reduced when impurities of larger particles are filtered and block the larger filtration pores of the filtration material. Moreover, the flow rate of liquid in the water filter will be greatly impaired during filtration. When the smaller filtration pores of the filtration material are not fully used, the filtration material has been replaced. In addition to failing to make the best use of the filter material and not in line with economic benefits, this action also imposes a burden on the environment.

Therefore, the present invention provides a water filter comprising at least two filtration layers, these layers include a nanofiber filtration layer and an activated carbon filtration layer. The present invention further provides a method for installing said at least two filtration layers, providing convenience for users to replace the filtration part. It at least provides the public with an alternative.

### SUMMARY OF THE INVENTION

The first aspect of the present invention is related to a liquid filter, having a filtration part for filtration of liquid, said filtration part at least comprising: a first filtration layer consisting of a first material; and a second filtration layer consisting of a second material, wherein the filtration of liquid in the filtration part is in the order of: a first filtration, taking place at said second filtration layer; and a second filtration, taking place at said first filtration layer.

In one embodiment, said filtration part having a channel for liquid flow, said first filtration layer and said second filtration layer are provided along the length of said channel, wherein said second filtration layer is closer to said channel than said first filtration layer, wherein, the flow direction of liquid in said filtration part is in the order of: said channel, said second filtration layer, and said first filtration layer. Preferably, said first filtration layer and said second filtration layer can be independently assembled to form said filtration part.

In one embodiment, said first material is nanofiber selected from nylon, n-polyacrylonitrile, polyurethane, or the combinations thereof. Preferably, that said second material is activated carbon. More preferably, the pore size of said first filtration layer is smaller than the pore size of said second filtration layer.

The second aspect of the present invention is related to a liquid filter, having a filtration part for filtration of liquid, said filtration part at least comprising: a first filtration layer consisting of a first material; a second filtration layer consisting of a second material; and a third filtration layer consisting of a third material, wherein the filtration of liquid in said filtration part is in the order of: a first filtration, taking place at said third filtration layer; a second filtration, taking place at said second filtration layer; and a third filtration, taking place at said first filtration layer.

In one embodiment, said filtration part having a channel for liquid flow, said first filtration layer, said second filtration layer, and said third filtration layer are provided along the length of said channel, wherein said third filtration layer is the closest to said channel, said first filtration layer is the farthest from said channel, said second filtration layer is positioned between said first filtration layer and said third filtration layer, wherein, the flow direction of liquid in said filtration part is in the order of: said channel, said third filtration layer, said second filtration layer, and said first filtration layer. Preferably, said first filtration layer, said second filtration layer, and said third filtration layer can be independently assembled to form said filtration part.

In one embodiment, said first material is nanofiber selected from nylon, n-polyacrylonitrile, polyurethane, or the combinations thereof; said second material is activated carbon; and said third material is non-woven fabric. Preferably, the material of said non-woven fabric is selectable from polyethylene non-woven fabric, polypropylene non-woven fabric, spunbonded non-woven fabric, melt-blown non-woven fabric, or spunlaced non-woven fabric. In one embodiment, the pore size of said third filtration layer is larger than the pore size of said second filtration layer, and the pore size of said second filtration layer is larger than the pore size of said first filtration layer. In one embodiment, the pore size of said third filtration layer is the same as the pore size of said second filtration layer and larger than the pore size of said first filtration layer.

In one embodiment, said liquid filter is provided with a frame, allowing said filtration part to be arranged along the length of said frame. Preferably, said first filtration layer is flexible, said second filtration layer is a prefabricated member, said first filtration layer being positioned between said second filtration layer and said frame. More preferably, the outer circumferential cross-section of said second filtration layer having a first geometric shape. In one embodiment, said first geometric shape is polygon-shaped. In another embodiment, said first geometric shape is star-shaped or wave-shaped.

In one embodiment, the inner circumferential cross-section of said frame having a second geometric shape, after said first filtration layer being arranged along the length of said frame, the cross-section of said first filtration layer assumes said first geometric shape and/or said second geometric shape. Preferably, said second geometric shape is polygon-shaped. More preferably, said second geometric shape is star-shaped or wave-shaped. In another embodiment, said first geometric shape is the same as said second geometric shape.

In one embodiment, said frame having a bottom part and a plurality of branches extending upward along its length from said bottom part, wherein each of said plurality of branches has a first end engaging with said bottom part and a second end opposite said first end. In particular, said plurality of branches of said frame extending upwards away from the central axis of said bottom part of said frame. Preferably, said first geometric shape having a recessed portion positioned corresponding to said plurality of branches of said frame. More preferably, after said first filtration layer being arranged along the length of said frame, the cross-section of said first filtration layer assumes said first geometric shape.

The third aspect of the present invention is related a method for installing a filtration part of the present invention, providing a convenient way for users to replace the filtration part. The method comprises the following steps: (i) providing a water inlet, a base member, said frame, a first filtration layer, and a second filtration layer; (ii) surrounding said first filtration layer along the length of said second filtration layer around the periphery of said second filtration layer to form a first assembly; (iii) surrounding said frame along the length of said first assembly around the periphery of said first assembly to form a second assembly; (iv) assembling said second assembly with said water inlet and said base member, wherein said second assembly is positioned between said water inlet and said base member.

In one embodiment, the method also includes the following steps in step (i): providing a third filtration layer inner-circumferentially to the central part of said second filtration layer.

In one embodiment, said first filtration layer is flexible, and said second filtration layer is a prefabricated member, in particular a rigid prefabricated member.

In one embodiment, said frame is a plurality of branches, having a first end and a second end opposite to said first end, said first end can be operationally connected to said base member, thereby said plurality of branches extending upward along its length from said base member. Preferably, said plurality of branches extending upwards away from the central axis of said base member. More preferably, the outer circumferential cross-section of said second filtration layer having a first geometric shape having a recessed portion positioned corresponding to the position of said plurality of branches of said frame.

### DESCRIPTION OF THE DRAWINGS

The present invention provides the following drawings, which are intended to introduce various embodiments of the present invention in detail and are not intended to limit the present invention, wherein:

FIG. 1 is a cross-sectional view of a filtration part according to an embodiment of the present invention;

FIG. 2 is a perspective view of a filtration part according to an embodiment of the present invention;

FIG. 3 is a perspective view of a filtering part according to an embodiment of the present invention.

FIG. 4 is an exploded perspective view of a liquid filter according to an embodiment of the present invention;

FIG. 5 is a top view of the embodiment of FIG. 4;

FIG. 6 is a schematic three-dimensional structural diagram of the embodiment in FIG. 4;

Inserts A to C in FIG. 7 are assembly schematic diagrams according to another embodiment of the present invention, representing the assembly between the first filter layer, the second filter layer, and the frame;

FIG. 8 is a top view of the embodiment of FIG. 7; and

FIG. 9 is a cross-sectional view of the filtration part of the embodiment of FIG. 7.

### DETAILED DESCRIPTION OF PREFERRED EMBODIMENTS OF THE INVENTION

In order to make the purpose, technical solution, and advantages of the present invention clearer, the following is a detailed explanation of the present invention in conjunction with specific embodiments and with reference to the accompanying drawings.

It shall be noted that, the technical or scientific terms used in the embodiments of the present invention shall have the general meanings understood by those skilled in the art to which the present invention belongs. “First”, “second” and similar expression used in the embodiments of the present invention do not indicate any quantity or importance. Terms such as “front”, “back”, “left”, “right”, “up”, and “down” indicating orientation or similar terms are only described for the exemplary relative position relationship shown in the accompanying drawings for the convenience of those skilled in the art to understand, and are not limited to the specific relative position relationship within the present invention.

The liquid filter of the present invention has a filtration part for liquid filtration. The liquid filter at least further comprises a water inlet and a filtered liquid collector. It can be understood that the water inlet is for unfiltered liquid to flow to the filtration part of the present invention for filtering, and the liquid filtered by the liquid filter of the present invention flows to the filtered liquid collector for use/to be used. For the sake of brevity, unless otherwise specified, the description and drawings will not provide detailed description on filters, water inlets, and filtered liquid collectors. Those skilled in the art should be aware of and use known methods or techniques to assemble the filters, water inlets, and filtered liquid collectors. For exemplary purposes, this description takes water as an example of liquid that needs to be filtered. However, the filtered liquid to which the present invention is applicable should not be limited to water.

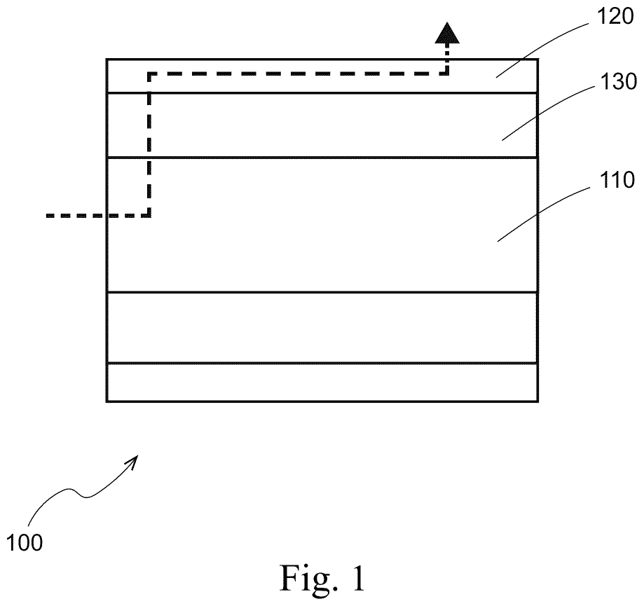

FIG. 1 shows a first embodiment of the filtration part of the liquid filter of the present invention. The filtration part 100 shown in FIG. 1 assumes cylindrical or tubular in shape. The filtration part 100 includes a channel 110, a first filtration layer 120, and a second filtration layer 130. The first filtration layer 120 and the second filtration layer 130 are constructed and manufactured so that they respectively have porous structures, wherein the pore size of the first filtration layer 120 is smaller than the pore size of the second filtration layer 130. The second filtration layer 130 is closer to the channel 110 than the first filtration layer 120. The first filtration layer 120 and the second filtration layer 130 can be independently assembled to form the filtration part 100. This means that users can selectively replace the first filtration layer 120 and/or the second filtration layer 130 according to needs.

The materials of the first filtration layer 120 include nanofiber, which can be selected from nylon, n-polyacrylonitrile, polyurethane, or the combinations thereof. Nanofibers made from polymers are well-known in this field, which is not described in details in the description. Due to the interweaving of nanofibers, the material has a porous structure. Therefore, the first filtration layer 120 according to the present invention can be configured to filter impurities of several sizes in the liquid. The materials of the second filtration layer 130 include activated carbon. Preferably, the activated carbon of the second filtration layer 130 can be in the forms of granules, rods, strips, sheets, etc. according to actual needs. Due to its porosity, it can adsorb microscopic substances in various liquids when filtering, which is commonly used in water treatment for decolorization, deodorization, dechlorination, and removal of organic matter and heavy metals. The principle and application of using activated carbon for filtering are well-known in this field, thus it is not described in details in the description. The above examples are only exemplary examples and shall not be understood as limitations to the present invention. The spirit of the present invention lies in the filtration part 100, the pore size of the first filtration layer 120 is smaller than the pore size of the second filtration layer 130. According to actual needs, the example of the material of the second filtration layer 130 can also be used for the first filtration layer 120, and the example of the material of the first filtration layer 120 can also be used for the second filtration layer 130.

When implementing the first embodiment, as shown by the dashed line in FIG. 1, unfiltered liquid first enters the channel 110 from the left side of the filtration part and then enters the second filtration layer 130. The unfiltered liquid first undergoes a first filtration at the second filtration layer 130. The liquid after the first filtration then enters the first filtration layer 120 and the second filtration takes place at the first filtration layer 120. The liquid after the second filtration then leaves the filtration part and enters the filtered liquid collector. The configuration of this first embodiment defines the unique direction in which liquid flows outward from the center of the filtration part. Compared with the prior art, in the process of liquid filtration in this embodiment, the flow direction of liquid is different from that of similar filters in the prior art, in which the flow direction of liquid is from the peripheral part of its filtration part inward to the central channel.

Even if the direction of the liquid flows into the channel 110 is horizontal in the embodiment shown in FIG. 1, those skilled in the art should understand that the teachings in the embodiment shown in FIG. 1 does not limit to the present invention. According to actual needs, those skilled in the art could configure, according to the first embodiment of the present invention, the direction of the liquid flows into the channel 110 such as entering from the right, from the top, or from the bottom. The spirit of the present invention lies in that the unfiltered liquid first has a first filtration at the second filtration layer 130, and then the liquid after the first filtration has a second filtration at the first filtration layer 120.

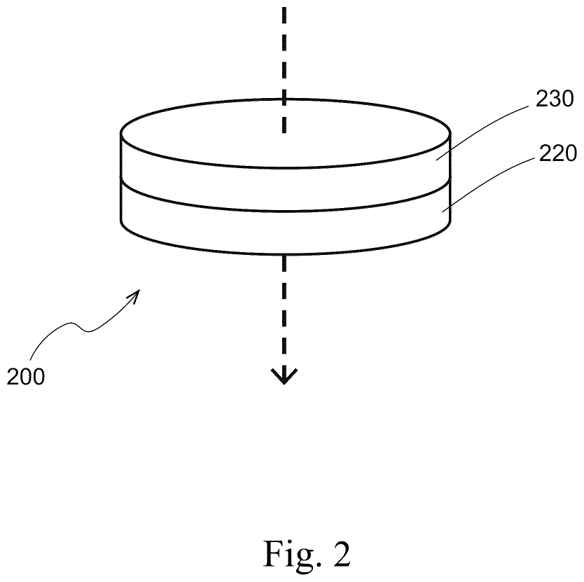

FIG. 2 is the second embodiment of the filtration part of the filter of the present invention. The filtration part 200 shown in FIG. 2 is in a form of sheets. The filtration part 200 includes a first filtration layer 220 and a second filtration layer 230. The first filtration layer 220 and the second filtration layer 230 are assembled in a stacked or laminated form to form a filtration part. The circular lamination shown in FIG. 2 is only an exemplary example. The first filtration layer 220 and the second filtration layer 230 can be independently assembled to the filtration part 200. This means that users can selectively replace the first filtration layer 220 and/or the second filtration layer 230 as needed. The materials of the first filtration layer 220 and the second filtration layer 230 are the same as the materials of the first filtration layer 120 and the second filtration layer 130, respectively, so it will not be elaborated further for brevity's sake. As shown by the dashed line in FIG. 2, the filter of the second embodiment is configured to enable the unfiltered liquid enters the filtration part 200 from the top of the filtration part and then leaves the filtration part 200. Therefore, the second filtration layer 230 is closer to the unfiltered liquid than the first filtration layer 220.

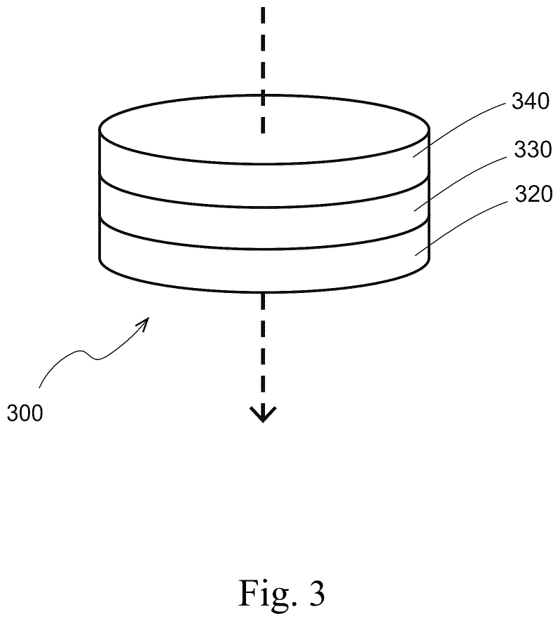

FIG. 3 is a third embodiment of the filtration part of the filter of the present invention. The filtration part 300 shown in FIG. 3 also assumes in a form of sheet. The filtration part 300 includes a first filtration layer 320, a second filtration layer 330, and a third filtration layer 340. The first filtration layer 320, the second filtration layer 330, and the third filtration layer 340 are assembled in a stacked or laminated form to form a filtration part. The first filtration layer 320, the second filtration layer 330, and the third filtration layer 340 can be independently assembled to the filtration part 300. This means that users can selectively replace the first filtration layer 320 and/or the second filtration layer 330 and/or the third filtration layer 340 as needed. The materials of the first filtration layer 320 and the second filtration layer 330 are the same as the materials of the first filtration layer 120 and the second filtration layer 130, respectively, so it will not be elaborated further for brevity's sake. The materials of the third filtration layer 340 include non-woven fabric. According to actual needs, materials of non-woven fabric can be selected from polyethylene non-woven fabric, polypropylene non-woven fabric, spunbonded non-woven fabric, melt-brown non-woven fabric, or spunlaced non-woven fabric. The interweaving of non-woven fabric fibers makes the material porous. Therefore, according to the present invention, the third filtration layer 340 can be configured to filter plurality of sizes of impurities in the liquid, wherein the pore size of the third filtration layer 340 is larger than the pore size of the second filtration layer 330, and the pore size of the second filtration layer 330 is larger than the pore size of the first filtration layer 320. The above examples are only exemplary examples and should not be understood as limitations to the present invention. According to actual needs, in one embodiment, the pore size of the third filtration layer 340 is the same as the pore size of the second filtration layer 330 but larger than the pore size of the first filtration layer 320. According to actual needs, the examples of the materials of the first, second, and third filtration layers can be used as materials for other filtration layers. According to the filtration part 300 of the present invention, the pore size of the first filtration layer 320 is smaller than the pore size of the second filtration layer 330, and the pore size of the second filtration layer 330 is smaller than the pore size of the third filtration layer 340. As shown by the dashed line in FIG. 3, when implementing the third embodiment, the unfiltered liquid first contacts the third filtration layer 340 from the top of the filtration part for the first filtration, then contacts the second filtration layer 330 for the second filtration, and then contacts the first filtration layer 320 for the third filtration. The liquid after the third filtration then leaves the filtration part and enters the filtered liquid collector.

As explained in the first embodiment, the teachings in the embodiments in FIGS. 2 and 3 should not be understood as limitations to the present invention. According to actual needs, those skilled in the art could configure, according to the second and third embodiments of the present invention, the direction of the liquid flows into the filtration part such as entering from the right, from the left, or from the bottom. The spirit of the present invention lies in that, in the second embodiment, the unfiltered liquid first undergoes a first filtration in the second filtration layer 230, and then the liquid after the first filtration undergoes a second filtration in the first filtration layer 220. For the third embodiment, the unfiltered liquid first undergoes a first filtration in the third filtration layer 340, then the liquid after the first filtration undergoes a second filtration in the second filtration layer 330, and then the liquid after the second filtration undergoes a third filtration in the first filtration layer 320. Those skilled in the art should understand that the first filtration layer, second filtration layer, or third filtration layer described in the description is not formed by only one layer of material. According to actual needs, those skilled in the art could configure the filtration layer is formed by at least one layer of material. In one embodiment, the first filtration layer 320 may include 10 layers of nanofiber material layers made of nylon, the second filtration layer 330 may include at least 1 material layer made of activated carbon, and the third filtration layer 340 may include 10 material layers made of non-woven fabric. In one embodiment, the first filtration layer 320 includes 5 layers of nanofiber material layer made of nylon and 5 layers of nanofiber material layer made of polyurethane, the second filtration layer 330 may include at least 1 layer of material layer made of activated carbon, the third filtration layer 340 may include 5 material layers made of polypropylene non-woven fabric and 5 material layers made of spunlaced non-woven fabric.

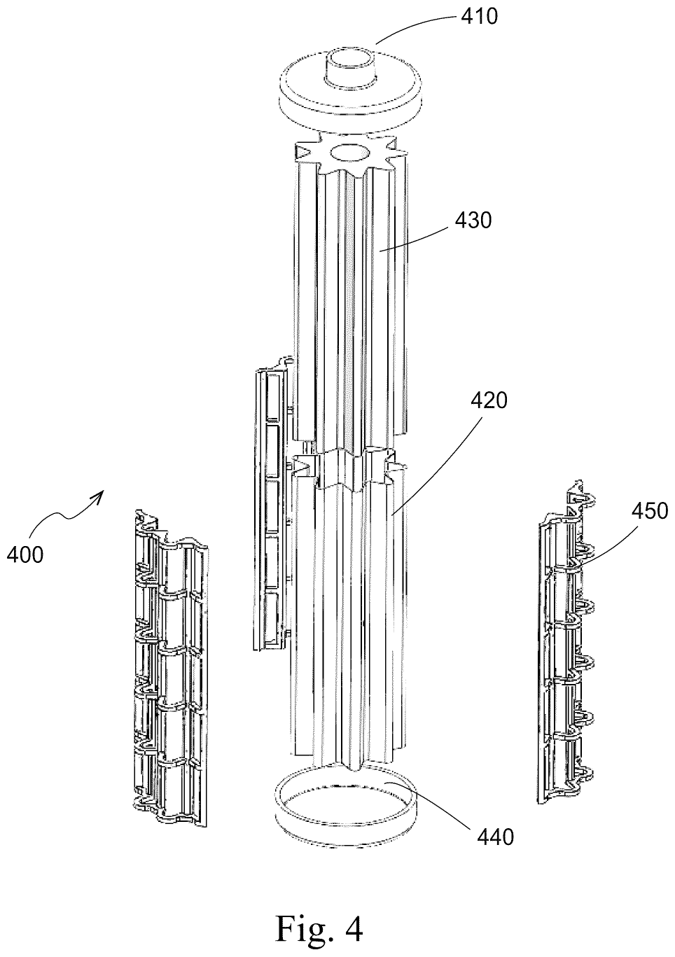

FIG. 4 is a fourth embodiment of the filtration part of the filter of the present invention. The filtration part 400 shown in FIG. 4 is columnar or cylindrical in shape. The filtration part 400 has a water inlet 410, a first filtration layer 420, a second filtration layer 430, and a base member 440. The first filtration layer 420 and the second filtration layer 430 are arranged between the water inlet 410 and the base member 440. The materials of the first filtration layer 420 and the second filtration layer 430 are the same as that of the first filtration layer 120 and the second filtration layer 130, respectively, so it is not elaborated further for brevity's sake. Although the fourth embodiment does not have a third filtration layer of the present invention, those skilled in the art should understand that according to actual needs, the filter part 400 may also be provided with the third filter layer of the present invention circumferentially inside the central part of the second filter layer 430.

As shown in FIG. 4, the second filtration layer 430 is configured such that its central part forms a channel (as the channel 110 shown in in FIG. 1) of the filtration part of the present invention. However, FIG. 4 is only an exemplary example, and according to actual needs, the filter can be provided with another separate component as a channel for liquid flow.

In this embodiment, the second filtration layer 430 can be a prefabricated member with a geometric shape, preferably a rigid prefabricated member. As shown in FIG. 4, the top part of the second filtration layer 430 and its outer peripheral cylindrical shape is a nine-pointed star. However, the example shown in FIG. 4 shall not be understood as limitations to the present invention. According to actual needs, the geometric shapes of the cross-section of the second filtration layer can be star-shaped, polygon-shaped, or wave-shaped or other. In this embodiment, the first filtration layer 420 can be a flexible member, preferably a paper member. As shown in FIG. 4, the second filtration layer 430 has a shape of nine-pointed star which is similar to the outer cylindrical shape of the first filtration layer 420. The shapes of the first filtration layer 420 and the second filtration layer 430 can increase the surface area for filtration, improving the filtration efficiency and the filter lifespan. The formation of the shape of nine-pointed star of the first filtration layer 420 can be obtained by folding paper members or by placing the first filtration layer 420 in the space formed by the frame 450 and the second filtration layer 430 during assembling.

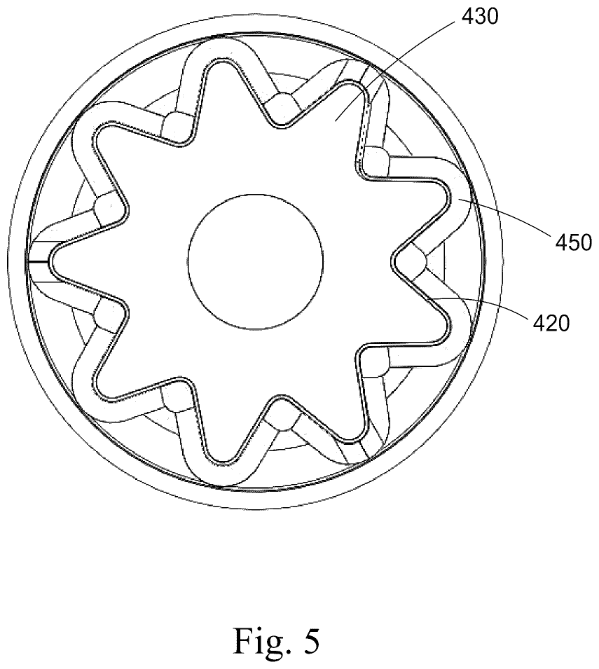

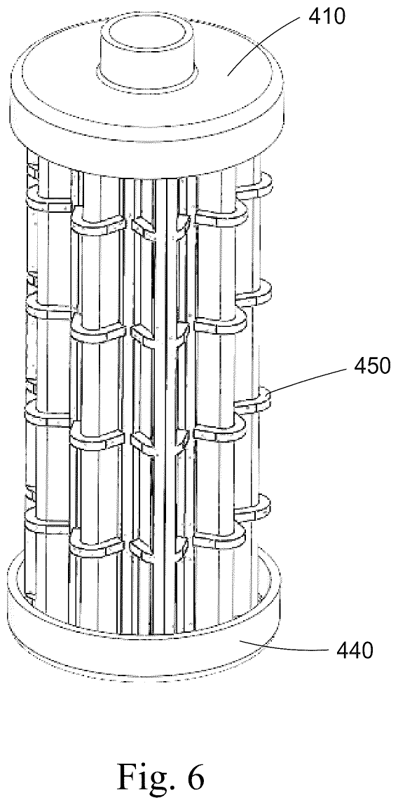

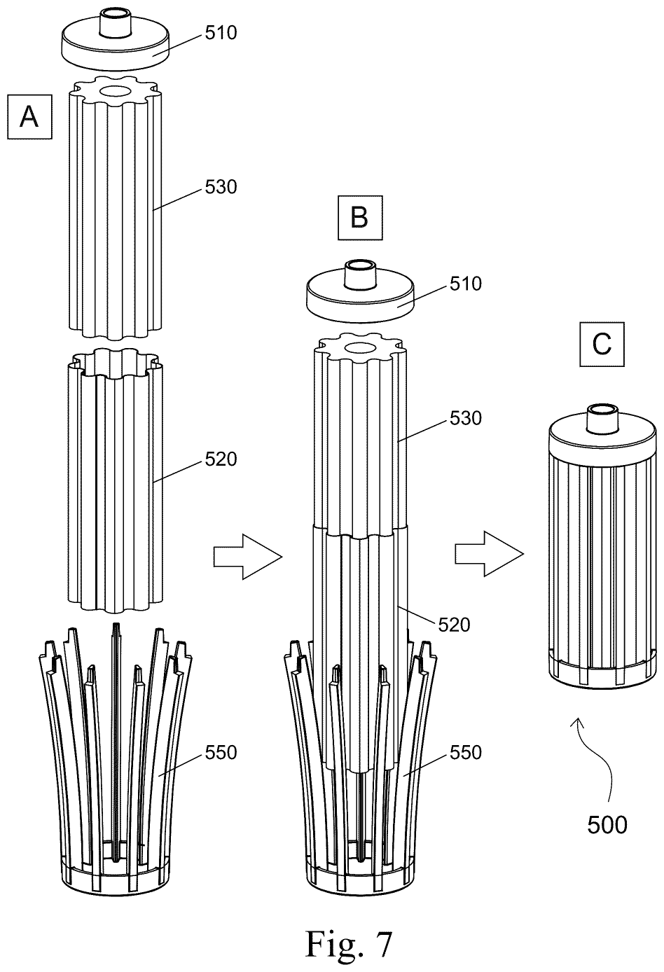

There are three frames 450 in FIGS. 4-6, which are arranged on the periphery of the first filtration layer 420 and surrounding the first filtration layer 420. However, due to actual needs, those skilled in the art could configure at least one frame 450. The arrangement of frame 450 is to provide convenience for assembling the first filtration layer, so that users do not need to fold the first filtration layer 420 in advance when placing the first filtration layer 420 into the filtration part of the present invention. Based on the narrow space formed by the frame 450 and the second filtration layer 430, the user press the non-folded first filtration layer 420 along the frame 450 against the periphery of the second filtration layer 430, so that after installation, the shape of the first filtration layer 420 will be the same as the cylindrical shape of the periphery of the second filtration layer 430, as shown in FIG. 5, which is a nine-pointed star shape. According to actual needs, the cross-sections of the frame 450 and the second filtration layer 430 can be any geometric shape, such as star-shaped, polygon-shaped, or wave-shaped, etc.

Inserts A-C in FIG. 7 are schematic diagrams of the fifth embodiment of the filtration part of the filter of the present invention, representing the assembly between the first filtration layer, the second filtration layer, and the frame. The filtration part 500 shown in FIG. 7 assumes in cylindrical or tubular shape. The filtration part 500 has a water inlet 510, a first filtration layer 520, a second filtration layer 530, and frame 550. The configuration and operation of the water inlet 510, the first filtration layer 520, and the second filtration layer 530 are the same as those of the water inlet 410, the first filtration layer 420, and the second filtration layer 430, respectively, so it is not elaborated further for brevity's sake.

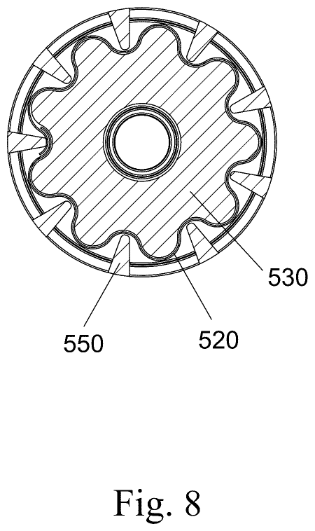

As shown in insert A in FIG. 7, a frame 550 of the filtration part 500 has a circular bottom part and a plurality of branches extending upwards along the length of the branches from the bottom part, wherein each of the plurality of branches has a first end engaging with the bottom part and a second end opposite to the first end. In some embodiments, the bottom part of the frame 550 can be the base member 440 in FIGS. 4-6. In this case, the plurality of branches can extend upwards from the base member. Preferably, as shown in FIG. 7, the upward extension of a plurality of branches is slightly away from the central axis of the circular bottom part, resulting in the second end of a plurality of branches is arranged to form an opening which is slightly larger than the bottom part, providing convenience for accommodating the first filtration layer 520, the second filtration layer 530, the frame 550, and the assembly therebetween. Further, preferably, the position of a plurality of branches in frame 500 corresponds to the geometric shape of the outer circumferential cross-section of the second filtration layer 530. As shown in in the inserts A and B in FIGS. 7, the first filtration layer 520 assumes a nine-pointed star shape, and the position of a plurality of branches in frame 550 corresponds to the recessed portion of the nine-pointed star shape. Therefore, as shown in the insert B in FIGS. 7 and 8, a plurality of branches of frame 550 is accommodated in the recessed portion of the outer wall of the second filtration layer 530.

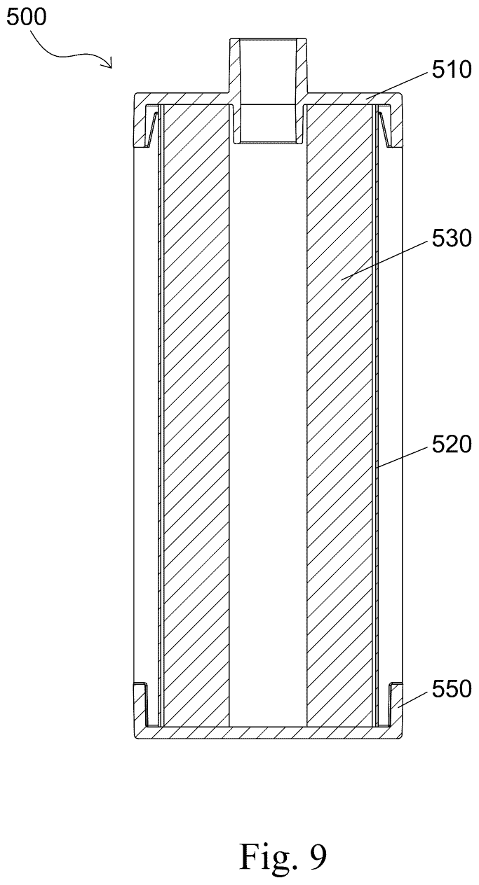

The assembly of the filtration part 500 in the fifth embodiment can be achieved by following the steps below: gently wrapping the first filtration layer 520, preferably in the form of a flexible paper member, around the periphery of the second filtration layer 530 to form a first assembly. Then, as shown in insert B in FIG. 7, placing the second filtration layer 530 and the first filtration layer 520 which is lightly attached to the second filtration layer 530 together in a space formed by a plurality of branches of frame 500 to form the second assembly. After the second assembly (i.e., the first filtration layer 520 and the second filtration layer 530) is in the space, the user can gently press the plurality of branches of frame 500 with the fingers to press the first filtration layer 520 onto the recessed portion of the outer wall of the second filtration layer 530. Then, assembling the second assembly with a water inlet and a base member, wherein the second assembly is located between the water inlet and the base member, that is, the water inlet 510 is assembled to cover the second end of the frame 500 to form the state of the filtration part 500 in the insert C in FIG. 7 and FIG. 9.

Although the invention has been described in conjunction with specific embodiments of the invention, many alternatives, modifications and variations of these embodiments will be apparent to those of ordinary skill in the art from the foregoing description. The present embodiments are intended to embrace all such alternatives, modifications and variations that fall within the broad scope of the appended claims. Therefore, any omissions, modifications, equivalent substitutions, improvements, etc. made within the spirit and principles of the embodiments of the present invention shall be included in the protection scope of the present invention.

1. A liquid filter, having a filtration part for filtration of liquid, said filtration part at least comprising:
a first filtration layer consisting of a first material;
a second filtration layer consisting of a second material; and
a frame, allowing said filtration part to be arranged along the length of said frame;
characterized in that,
said frame is arranged on the periphery of said first filtration layer and is arranged surrounding said first filtration layer, said first filtration layer is installed in a space formed by said frame and said second filtration layer, such that the shape of said first filtration layer after installation is the same as the peripheral shape of said second filtration layer.

2. The liquid filter according to claim 1, characterized in that the outer circumferential cross-section of said second filtration layer having a first geometric shape.

3. The liquid filter according to claim 2, characterized in that said first geometric shape is polygon-shaped including star-shaped or wave-shaped.

4. The liquid filter according to claim 1, characterized in that after said first filtration layer is arranged along the length of said frame, said first filtration layer is in close contact with the periphery of said second filtration layer along the length of said frame, such that the cross-section of said first filtration layer assumes said first geometric shape.

5. The liquid filter according to claim 1, characterized in that the inner circumferential cross-section of said frame has a second geometric shape, after said first filtration layer is arranged along the length of said frame, said first filtration layer is in close contact with the periphery of said second filtration layer along the length of said frame, such that the cross-section of said first filtration layer assumes said first geometric shape and/or said second geometric shape.

6. The liquid filter according to claim 5, characterized in that said second geometric shape is polygon-shaped including star-shaped or wave-shaped.

7. The liquid filter according to claim 5, characterized in that said first geometric shape and said second geometric shape are the same.

8. The liquid filter according to claim 1, characterized in that said frame having a bottom part and a plurality of branches extending upward along its length from said bottom part, wherein each of said plurality of branches has a first end engaging with said bottom part and a second end opposite said first end.

9. The liquid filter according to claim 8, wherein said plurality of branches of said frame extending upwards away from the central axis of said bottom part of said frame.

10. The liquid filter according to claim 8, characterized in that, said first geometric shape having a recessed portion positioned corresponding to said plurality of branches of said frame.

11. The liquid filter according to claim 9, characterized in that, said first geometric shape having a recessed portion positioned corresponding to said plurality of branches of said frame.

12. The liquid filter according to claim 7, characterized in that, the filtration of liquid in the filtration part is in the order of:
a first filtration, taking place at said second filtration layer; and
a second filtration, taking place at said first filtration layer;
wherein said second filtration layer is constructed such that its central portion forms a channel for liquid flow, said first filtration layer is provided along the length of said channel,
characterized in that,
the flow direction of liquid in said filtration part is in the order of: said channel, said second filtration layer, and said first filtration layer; and
said first filtration layer and said second filtration layer can be independently assembled to form said filtration part.

13. The liquid filter according to claim 7, said filtration part further comprising a third filtration layer consisting of a third material, the filtration of liquid in said filtration part is in the order of:
a first filtration, taking place at said third filtration layer;
a second filtration, taking place at said second filtration layer; and
a third filtration, taking place at said first filtration layer;
wherein said second filtration layer is constructed such that its central portion forms a channel for liquid flow, said first filtration layer is provided along the length of said channel,
characterized in that,
the flow direction of liquid in said filtration part is in the order of: said channel, said third filtration layer, said second filtration layer, and said first filtration layer; and
said first filtration layer, said second filtration layer, and said third filtration layer can be independently assembled to form said filtration part.

14. The liquid filter according to claim 12, characterized in that:
said first material is nanofiber selected from nylon, n-polyacrylonitrile, polyurethane, or the combinations thereof, and said second material is activated carbon; and
the pore size of said first filtration layer is smaller than the pore size of said second filtration layer.

15. The liquid filter according to claim 13, characterized in that:
said first material is nanofiber selected from nylon, n-polyacrylonitrile, polyurethane, or the combinations thereof; said second material is activated carbon; and said third material is non-woven fabric;
the pore size of said third filtration layer is larger than the pore size of said second filtration layer, and the pore size of said second filtration layer is larger than the pore size of said first filtration layer; or the pore size of said third filtration layer is the same as the pore size of said second filtration layer and larger than the pore size of said first filtration layer.

16. A method for installing a liquid filter according to claim 1, comprising the following steps:
(i) providing a water inlet, a base member, said frame, a first filtration layer, and a second filtration layer;
(ii) surrounding said first filtration layer along the length of said second filtration layer around the periphery of said second filtration layer to form a first assembly;
(iii) surrounding said frame along the length of said first assembly around the periphery of said first assembly to form a second assembly;
(iv) assembling said second assembly with said water inlet and said base member, wherein said second assembly is positioned between said water inlet and said base member.

17. The method according to claim 16, wherein step (i) further comprising the following step: providing a third filtration layer inner-circumferentially to the central part of said second filtration layer.

18. The method according to claim 16, wherein said first filtration layer is flexible, and said second filtration layer is a prefabricated member.

19. The method according to claim 18, wherein said frame is a plurality of branches, having a first end and a second end opposite to said first end, said first end can be operationally connected to said base member, thereby said plurality of branches extending upward along its length from said base member.

20. The method according to claim 19, wherein said plurality of branches extending upwards away from the central axis of said base member; the outer circumferential cross-section of said second filtration layer having a first geometric shape having a recessed portion positioned corresponding to the position of said plurality of branches of said frame.
